(19) United States
(12) Patent Application Publication
(10) Pub. No.: US 2026/0015795 A1
(43) Pub. Date: Jan. 15, 2026

(54) PROCESS TO PRODUCE A FUNCTIONAL PRE-PREG MAT FROM LIGNO-CELLULOSIC MATERIALS

(71) Applicants: LIGNUTECH OY, Helsinki (FI); FIBERDOM OY, VANTAA (FI)

(72) Inventor: Duncan MAYES, HELSINKI (FI)

(73) Assignees: LIGNUTECH OY, Helsinki (FI); FIBERDOM OY, VANTAA (FI)

(21) Appl. No.: 18/994,731

(22) PCT Filed: Jul. 20, 2023
(86) PCT No.: PCT/FI2023/050445

§ 371 Date: Jan. 15, 2025

(30) Foreign Application Priority Data
Jul. 20, 2022 (GB) 2210622.3

(51) Int. Cl. D21H 11/20; C08J 3/24; C08J 5/06; D21J 3/00

(52) U.S. Cl. CPC D21H 11/20; C08J 3/24; C08J 5/06; D21J 3/00; C08J 2397/02

(57) ABSTRACT

A process for the manufacture of a functional pre-preg mat of ligno-cellulosic material is disclosed. In said process, pulp fibres are mixed with at least one functional solution including a cross-linking formulation. The cross-linking formulation has been prepared by dissolving at least one cross-linking agent in a water or alcohol based solvent at a temperature below 120° C. Pulp fibres treated with the at least one functional solution are then formed into an continuous mat. The mat of pre-preg ligno-cellulosic pulp fibres formed in the previous step is transferred to a drying step during which the temperature within the ligno-cellulosic mat is kept below 120° C. A functional pre-preg mat of ligno-cellulosic material suitable for use as raw material in a thermoforming process is also disclosed.

### OBJECT OF THE INVENTION

The present invention relates to a process for the manufacture of a functional pre-preg mat of ligno-cellulosic material, a functional pre-preg mat of ligno-cellulosic material obtainable by such a process and use of such a pre-preg mat in a thermoforming process.

### BACKGROUND OF THE INVENTION

Pre-preg materials are commonly manufactured from glass fibres, carbon fibres, basalt fibres or aramid fibres to produce a material suitable for use in a variety of applications, such as construction parts of motor vehicles and sea vessels, sport equipment, medical equipment, and in electrical engineering and various construction and consumer products. The fibres may be assembled into the form of a woven or non-woven mat, with said fibres either being pre impregnated prior to forming into a mat or impregnated with a polymeric matrix functioning as a binder or a filler once as a mat. Typically, the fibres or mat are treated by conveying through a resin bath. Commonly different kinds of thermosetting resins are used as binders, such as epoxy or phenolic resins, which then are only partially cured to allow easy handling. A hardener, such as a catalyst, may be used to initiate or promote the curing process that most commonly is temperature dependent, and which may be carried out during the final shaping of the product in a forming press. The pre-preg technique allows for industrial scale impregnation of fibres on a flat workable surface, and later shaping and forming of a product, as long as the resin remains only partially unreacted. The resulting material is very strong and durable and may be used in high demand applications. Traditionally this technique has been used with non-renewable composite materials only, with only some examples of long natural fibre mats such as hemp produced using a special needling process to form the mat prior to impregnation with a thermosetting resin such as melamine or phenolic or polyamide combined with formaldehyde cross-linkers.

The use of renewable raw materials is a key factor in reducing the carbon footprint of end products, which is especially important for single use and short lifespan products. This applies both for the initial energy intensity and carbon footprint of the raw material extraction and production and also the ability to recycle the product after reaching end of life.

Products derived from wood or other ligno-cellulosic raw materials, such as straw, are a natural choice for renewable materials, but at least when processed into pulp for further formation of products, there is a challenge to reach a high enough moisture resistance and dimensional stability due to the inherent hydrophilic nature of the material, and still not affect the ease of recycling of the product too much. When exposed to moist or varying humidity environments or when used in applications where the product may come into contact with high humidity, moisture, liquids, or grease conditions, untreated products produced from pulp will lose its strength, hold moisture and increase the risk of microbial growth and will often no longer provide the needed functionality it was intended for. This limits its use as a replacement to conventional thermoplastic materials such as polypropylene, polyethylene, high-density polyethylene (HDPE), and polyvinyl chloride (PVC). To address these limitations, barriers, coatings or films are usually applied to the surfaces of the substrate or product which prevent or limit the negative impacts of moisture and grease and surface abrasion. Traditionally fossil based polymer films, such as linear low-density polyethylene (LLDPE), has been used but in more recent times a number of advancements in bio derived films and barriers have been in development and are beginning to enter the market, such as polylactic acid (PLA) and latex. However, a number of challenges remain which still creates limitations on the use of ligno-cellulosic materials as a replacement to plastics and other fossil derived polymers, or composites. The application of a film coating on the surfaces helps to protect the direct surfaces but does not limit the risk of moisture and grease incursion and degradation from the edges of the boards and at joints and if the barrier is broken the functionality is lost. In addition, the use of a plastic barrier increases the complexity of the recycling and reprocessing of the ligno-cellulosic material as the very different materials need to be carefully separated before re-processing is possible.

One benefit with ligno-cellulosic materials derived from pulp is that a growing number of countries have developed effective recycling systems to collect and re-process pulp derived materials, such as cardboard and paper materials, for re-use into new products. An additional driver for conversion to renewable and non-plastic containing short life span products is the Single Use Plastics directive within the European Union (EU), which prevents the use of plastics in a growing number of single use products such as cutlery and the directive has even extended to prevention of use of plastic barriers, films or linings in combination with renewable pulp-based materials. For higher durability products, such as those used in the transport or construction sector, an extremely important factor in new material design is the ability to disassemble the products and where possible back into the original constituent materials to allow for either reuse into similar products or cascaded into new products in accordance with the EU waste management hierarchy framework.

Consequently, there is still a need to address the increasing demand for a fully renewable, sufficiently durable for its intended use, and easy to process raw material for products that traditionally has a short lifespan, or as an alternative to fossil-based plastics or composites in more permanent solutions requiring higher physical and biological durability, and where the material of the end product can be fully recycled and re-processed in a circular economy.

### PRIOR ART

There are several techniques known in the art for obtaining pre-preg materials that are further used as raw materials for the manufacture of high technical performance end products. Most of these materials are based on fibres that are not produced from renewable sources, are highly energy intensive to extract and produce, and are not bio-degradable, such as glass fibres or carbon fibres, while functionalisation of bio-degradable fibres, such as ligno-cellulosic fibres have been performed, for example, to increase the wet strength of the material in the final product, such as in absorbent hygiene products, or used to aid the manufacturing process, such as in paper and board production.

One early example of the preparation and utilisation of pre-preg materials is presented in publication U.S. Pat. No. 3,859,162 (A). The publication discloses use of isocyanate-containing polycarbodiimide prepolymers and a fibrous reinforcing material, such as glass fibres. A prepolymer powder is deposited onto the fibres, and the treated fibrous material is then passed through a heated zone under conditions such that the powder melts, flows and coats the surface of the reinforcing material. The polymers may be cross-linked to a greater or lesser extent depending on the intended use. Lightly cross-linked pre-pregs, that are not yet substantially thermoset, can be formed into shapes by the application of pressure and/or heat, and subsequently further cross-linked by the application of heat to form a rigid thermoset structure.

Another example of the preparation of pre-preg materials is disclosed in publication U.S. Pat. No. 4,649,080 (A), relating to mouldings which consists of heat stable plastics reinforced with oriented fibres, and a process for the preparation of such fiber reinforced materials by applying the plastics on such reinforcing fibres. The impregnated fibres, such as glass fibres, are arranged into a sheetlike structure or a three-dimensional structure. After curing, the fibre-reinforced material obtained possesses good strength properties, heat distortion resistance and resistance to solvents. Common for such pre-preg materials is that the fibre matrix is treated and in a later step shaped and cured into final form.

When bio-degradable fibres are used as raw material, the fibre matrix is commonly treated with additives providing desired properties to the material. Such additives may improve the surface structure, moisture resistance and strength of the material. Cross-linking of the ligno-cellolusic structure is one example of such treatment improving or changing the properties of the bio-based material. One example of such treatment is the combination of citric acid or similar carboxylic acids and sorbitol or similar polyols as a base formulation to facilitate an esterification reaction with the hydroxyl groups within the acid and also within wood fibres. This reaction is well known and at it earliest incorporated to a patent U.S. Pat. No. 3,661,955 (A) with the title “Polyesters of citric acid and sorbitol” having a priority date of 3 Nov. 1969 and a later and even more relevant patent CA2443901 C with the title “Cross-linked pulp and method of making the same” having a priority date of 11 Apr. 2001. The Canadian patent primarily refers to the use of carboxylic acid or maleic acid as the cross-linking additive which is to be applied via various means to pulp with intended outcome of an esterification reaction with the cellulosic pulp fibres to improve wet strength in the use of hygiene products.

The above-mentioned prior art related to the use of renewable fibres focuses on improving the absorbency and wet resiliency properties of cellulosic pulp materials and do as such solve a problem opposite to the one of the present invention, which aims to provide a raw material suitable for formation of products which limit liquid absorbance for the duration of its use and improved dimensional stability and strength properties using exclusively or primarily renewable raw materials which can be disassembled and recovered at the end of life.

### DESCRIPTION OF THE INVENTION

The present invention relates to a process to produce a functional pre-preg sheet material from ligno-cellulosic material intended for further processing to a final product. The process enables mass production of fully bio-based, biodegradable and recyclable sheet-like materials having a high grammage. Pre-treating ligno-cellulosic fibres with a functional solution prior to formation into a mat ensures effective dispersion and coating of the individual fibres or fibre bundles which when assembled into a continuous mat where the final cross-linking reactions have not yet occurred provides a valuable multiple end use material which when further processed can be reacted to create a strong, stable and multifunctional product. Such ligno-cellulosic fibres are herein referred to as ligno-cellulosic fibres, or simply pulp fibres. The functional pre-preg mat obtainable in the process is well suited as raw material for thermoforming, providing a sustainable and economically viable alternative for plastics or other non-renewable composites. After final curing, it also provides improved dimensional stability and strength compared to non-functionalised materials derived from lingo-cellulosic pulp manufactured using conventional methods.

The functional pre-preg sheet material is produced as an elongated mat, preferably reeled onto a roll like paper or cardboard to enable easier and more scaled processing in the final product production, alternatively it may be further cut to individual sheets. The functional pre-preg mat obtained in the process is primarily consisting of a pulp or fibre web derived from a wide variety of ligno-cellulosic raw materials, which have been refined into fibres or bundles of fibres. The continuous ligno-cellulosic mat obtained may contain a range of functional additives which are intended to provide a variety of different properties, such as increased stiffness (MoE), increased bending strength (MoR) and increased strength and stability when exposed to moisture, both in the form of vapor and in the form of liquid. Other functionality may include water or certain liquid repellence, fixation of additives which provide biological durability, UV resistance and even fire retardancy.

The functional additives that are applied to and contained within the functional pre-preg mat will be mostly unreacted at the end of the production process, but the surface coating of the fibres ensure that the fibres when assembled into a mat remain intact to the extent needed to reel the mat to a roll and maintain sufficient strength to be used industrially in the further final product production. The term pre-preg is herein to be interpreted as a pre-treatment suitable for materials designed for further modification before final curing. This pre-preg sheet material, containing functional additives in unreacted or uncured form, may then be used as such or shaped or combined with other layers of material before being pressed into a product shape. The product forming step is a process separate from the process for the manufacturing of the functional pre-preg mat, although the two processes may be combined into a single continuous process. Such a product forming step may either be directly integrated in a pulp mill or performed at a separate processing plant. A wide variety of pressing technologies commonly known in the art, such as roll forming, hydraulic pressing, or isostatic pressing are suitable for use with the functional pre-preg mat obtained in the disclosed process. In a further step, the final formed products may be reacted within an environment of elevated heat achieving cross-linking reactions, such as esterification reactions between hydroxyl groups of the ligno-cellulosic material and carboxyl groups of a cross-linking agent, such as an organic cross-linking acid. The cross-linking reaction may also be enhanced by the use of a catalyst. The process is a significant advancement to current processes for production of three-dimensional products of renewable and recyclable raw materials, currently mostly relying on suction moulding of ligno-cellulosic pulp. The functional pre-preg mat being dried to a moisture content essentially corresponding to an equilibrium moisture content with respect to ambient air reduces the need to dry the material in several steps prior to processing. The dry mat, including functional agents, of which at least one is a cross-linking agent in unreacted state, provides for a raw material that is easy to handle and stable enough for transfer into a forming process after which the material is reacted and cured to a final product shape. The method of manufacture also allows for the formation of a high grammage pre-preg material, thus reducing the need for extra materials handling when a certain durability is needed, otherwise requiring multiple layers of standard thickness pulp sheet material. A further objective is to provide a process which can incorporate waste trimmings and cuttings derived from the process, or materials that have been processed using similar techniques. This possibility reduces the amount of waste material to a minimum, as the still uncured raw material may be reprocessed and fed back to the production process. One benefit of the invention is that the process may be integrated into common pulp-mills, without the need of costly modifications and additional infrastructure.

The invention provides for a cost-effective and streamlined process for industrial scale production of fully bio-based and recyclable products that are strong enough to at least partially replace plastics and non renewable composite materials currently used in a variety of applications. The functionalisation of the ligno-cellulosic fibre material, such as ligno-cellulosic pulp material, provides for increased strength properties both in dry conditions and when exposed to moisture and liquid for a limited period of time but is still being fully recyclable with conventional cardboard products. To achieve full recyclability properties, it is beneficial to have a product with high ligno-cellulosic content and a ratio of solids content of crosslinking agents that is optimised in relation to the needed strength and performance in end use. At the same time, especially for the short life span products, the product should not be too strong so that the product is not possible to easily break down in a mechanical and water agitation process typically used in cardboard and paper recycling processes to obtain individual cellulose fibres for new cardboard or paper products.

### SUMMARY OF THE INVENTION

The object of the present invention is to provide a renewable and fully recyclable, pre-preg mat that is easy to handle and is suitable for processing into final products showing improved strength and moisture resistance properties due to the presence of functional additives within the raw material.

The present invention provides a process for the manufacture of a functional pre-preg mat of ligno-cellulosic material, in which process ligno-cellulosic fibres, such as pulp fibres are mixed with at least one functional solution. The at least one functional solution includes a cross-linking formulation containing at least one cross-linking agent, whereby the cross-linking formulation has been prepared by dissolving the at least one cross-linking agent in a water or alcohol based solvent at a temperature below 120° C. The ligno-cellulosic fibres, such as pulp fibres treated with the at least one functional solution are then discharged to a dewatering process where excess solution is removed and the treated pulp fibres are formed into a continuous mat. The lignocellulosic fibres, such as pulp fibres, are preferably transferred to the dewatering process via a headbox device in a consistency ranging from 0.5-10%, more preferably 1-3%. The mat of pre-preg ligno-cellulosic fibres, e.g. pulp fibres, formed in the previous step is transferred to a drying step during which the temperature within the ligno-cellulosic mat is kept below 120° C., the drying preferably being performed until the moisture content of the mat is 20% or less, even more preferably 15% or less.

In a preferred embodiment of the invention, the at least one cross-linking agent is a carboxylic acid having at least two carboxyl groups in combination with a polyol. In a further embodiment of the invention, the at least one cross-linking agent is dimethyloldihydroxyethylene urea (DMDHEU).

The at least one functional solution used in the treatment step may optionally include further additives or functional agents. In one embodiment of the invention, a hydrophobation emulsion is added to the step of treating pulp fibres with said at least one functional solution. Such a hydrophobation emulsion may comprise at least one hydrophobic agent including at least one substance selected from fatty acid esters, fatty alcohols and pentacyclic triterpenoids, such as oleanolic acid, betulin and betulinic acid. The hydrophobation emulsion may alternatively, or in addition, comprise at least one hydrophobic agent selected from a range of natural oils and waxes, preferably the hydrophobic agent is carnauba wax.

In a further embodiment of the invention, the at least one functional solution used in the mixing step includes additional lignin and a pH buffer. In another embodiment of the invention, a fire-retardant additive is included in the step of treating pulp fibres with the at least one functional solution.

The mixing of the pulp fibres and the at least one functional solution is preferably performed at a temperature of 25-95° C. The residue solution removed in the dewatering process is preferably recirculated to the step of mixing pulp fibres and the at least one functional solution, preferably through an intermediate tank from which the recirculated solution may be re-dosed into the process.

In order to obtain a pre-preg mat suitable for high durability applications, the pre-preg mat may be prepared as a high grammage material. The thickness of the functional pre-preg mat of ligno-cellulosic material obtained from the drying step is preferably 1.5-5 mm. The grammage of the functional pre-preg mat of ligno-cellulosic material obtained from the drying step is preferably 1500-5000 g/m².

A major advantage of the presented invention is the ability to re-pulp the intermediary or final products back into pulp fibres with very high recovery rates, maximising the use of the raw material. This is an especially preferred embodiment of the invention, wherein uncured waste material of ligno-cellulosic pulp fibres treated with at least one cross-linking formulation, in the same or different process, is recycled into the step of mixing pulp fibres with the at least one functional solution.

A further object of the invention is a functional pre-preg mat of ligno-cellulosic material suitable for use as raw material in a thermoforming process, the functional pre-preg mat of ligno-cellulosic material being obtained by a process as described above. The present invention also discloses the use of such a functional pre-preg mat of ligno-cellulosic material in a thermoforming process, wherein the pre-preg mat of ligno-cellulosic material is formed into a product and cured. The presence of at least one unreacted cross-linking agent within the pre-preg mat provides an easy-to-handle raw material, that upon thermoforming and curing provides enhanced strength and moisture resistance properties.

The process of the invention is designed such that the cross-linking agents react selectively with the amorphous region on the surface of the cellulose fibres to obtain needed strength in service but at the same time allow for easy re-hydrolysis, decoupling and repulping at the end of life. This pre-preg mat of lignocellulosic material is suitable as raw material for the formation of products showing increased stability within the ligno-cellulosic material and significantly reduced moisture uptake, thus providing a high-durability, pulp-based product having very high content of ligno-cellulosic fibres, making it both recyclable and suitable for use in single-use products as well as more permanent solutions.

The possibility to introduce a wide range of functionalisation agents, such as hydrophobic agents and agents having antibacterial properties or fire retardants widens the range of possible applications. The introduction of such agents already in the mixing stage, where the cross-linking formulation is blended with a pulp mass, enables the production of a material having very evenly distributed functionalisation. The mixing may be performed by combining different functional additives prior to mixing with the pulp, or by adding different functional additives directly into the mixing unit separately, either as pre-prepared solutions or as functional additives dissolving in the mixing unit. The functional pre-preg mat obtained from the drying step may still be easily processed into final products. When the pre-preg ligno-cellulosic mat is used for the production of such end products, a final curing reaction which may be carried out in a separate process after the product forming step fixates the functionalisation agents and additives present in the pre-preg mat within the cross-linked structure of the ligno-cellulosic material.

### DRAWINGS

The process of the invention is further described with reference to FIG. 1, presenting a non-limiting example of an especially preferred embodiment of the invention. The process of FIG. 1 includes optional steps of recycling solution and raw material into the treatment step. The functional pre-preg mat obtained in the process is suitable for thermoforming into end products, which is disclosed in FIG. 1 as an optional process.

FIG. 2 presents an FTIR spectra for pulp treated with the inclusion of a catalyst and for pulp treated without the inclusion of a catalyst and reacted at 130° C.

FIG. 3 presents an FTIR spectra for pulp treated with the inclusion of a catalyst and for pulp treated without the inclusion of a catalyst and reacted at 170° C.

### Definitions

The term pre-preg ligno-cellulosic mat herein refers to a sheet-like material which contains a combination of ligno-cellulosic fibres and additives. The ligno-cellulosic fibres have been treated with a variety of optional functional additives contained within the mat and which when further activated or reacted will provide specific functional properties to the final product, such as strength, hydrophobicity, or biological durability.

The term ligno-cellulosic material herein refers to any kind of plant-derived material containing cellulose or cellulosic fibres, either in its natural form or in processed form. Typically, the ligno-cellulosic material contains the natural polymers lignin, hemicellulose and cellulose or cellulosic fibres. The ligno-cellulosic material may be derived from all living plants and the like, such as but not limited to cotton, hemp, straw, flax, palm, bamboo and other grass like plants and the likes. The term ligno-cellulosic material also comprises all kinds of refined products derived from such ligno-cellulosic fibres, such as different kinds of cellulosic pulp. In other words, the ligno-cellulosic fibres may be ligno-cellulosic pulp or other fibrillated ligno-cellulosic material.

Bio-based is herein to be understood as a material or a compound that is obtainable from a natural source or any combination of such materials or compounds. Herein the term bio-based also includes synthetically produced equivalents to such compounds and mixes consisting essentially of such compounds. The term bio-based also refers to any unprocessed or processed renewable material, especially plant-based materials.

By functional solution is herein meant a solution, emulsion or dispersion of functional additives in water or similar functionality solvent, such as alcohol, especially ethanol. The functional solution is designed to be applied to a ligno-cellulosic matrix, herein ligno-cellulosic fibres, in particular pulp fibres, such that the ingredients and additives provide specific properties to the final product. Thereby, the treatment solution is a functional solution. The term functional solution comprises individual solutions of functional additives, as well as a solution of combined functional additives or combined functional solutions. The term functional solution may also comprise dispersions of additives or reaction products formed by combined additives.

The term recyclable herein refers to a product being recyclable together with conventional products produced from the same base raw material. There is no need to separate binding or functional agents present within the material prior to recycling as such agents are chosen from a range of agents that can be fully blended into the recycled material without significant negative effects, such as increased toxicity, formation of harmful components, or formation of clumps. A recyclable product may, however, have barriers that are designed and applied to a fully recyclable core material, such that the core material may be separated and recycled, the barrier material potentially being recycled in a separate process.

### DETAILED DESCRIPTION OF THE INVENTION

The functional pre-preg mat of ligno-cellulosic material obtained in the process of the present invention is a sheet-like material containing at least one unreacted functional cross-linking additive. The functional pre-preg mat may also contain further functional agents, such as water repellent, anti-microbial, or fire retardant additives. The intention is that the functional pre-preg mat of ligno-cellulosic material obtained in the process of the invention will be further processed into a product of final shape, preferably via any pressing or thermoforming technique known in the art, such as via hydraulic press forming or via a rotary roll press forming step. The functional pre-preg material may also act as a core layer for products which may have a top and bottom film or coating applied through lamination during the forming stage, thus providing a highly durable product, preferably for use in construction or the transport sector.

All kinds of ligno-cellulosic fibres, such as ligno-cellulosic pulp fibres produced using techniques known in the art are suitable for use in the process of the present invention. Such ligno-cellulosic pulp fibres may be conventional ground wood or thermo-mechanical fibres that are still in a “never dried” nature, or pulp derived from the bleach kraft pulping process which has also never been dried or optionally have been dried previously. The ligno-cellulosic fibres may also include ligno-cellulosic fibres derived from recycled materials such as medium density fibre board or recovered fibre based packaging. A broad variety of pulp types are suitable for the process including but not limited to thermo-mechanical, chemi-thermomechanical pulp (CTMP), softwood and hardwood kraft pulps, dissolving pulp, recycled pulp, pulp derived from alternative agricultural ligno-cellulosic fibres such as hemp, flax, bagasse, palm, rice stems, straw, bamboo, and the likes. Ligno-cellulosic fibres from such sources are also suitable for use in the method of the present disclosure. The process of the invention is suitable for industrial scale production of a pre-preg ligno-cellulosic mat. The process may be integrated into common pulp mills, preferably small or medium size forming lines.

In the process of the present invention, ligno-cellulosic fibres, such as ligno-cellulosic pulp fibres, are introduced into a mixing unit for contacting the pulp fibres with at least one functional solution, thus functioning as the treatment solution. The functional solution is water based, or alternatively, it may be at least partially prepared in a base of similar functionality solvent, such as alcohol, e.g., ethanol.

The step of mixing the pulp fibres with the at least one functional solution is preferably carried out in a standard mixing unit commonly used in the pulp fibre preparation process. The solvent, most commonly water, may either be in liquid stage, or the mixing may be performed at an elevated temperature in steam. The pulp fibres may be added to the mixing unit in wet or dry form. The pulp fibres are mixed with the at least one functional solution for a period of time that allows essentially all fibres to be treated with the additives of said at least one functional solution. Since the treatment is carried out in a base solution of water, or similar functionality solvent, the time required to ensure equal coating on individual pulp fibres or fibre bundles is relatively short, typically in the range of 60-180 s, without being limited thereto. It may be beneficial to carry out the mixing at elevated temperatures of between 25 and 95° C., even more preferably at a temperature of 40-95° C. Said at least one functional solution comprises at least one naturally derived cross-linking agent, optionally in combination with other functional agents.

The naturally derived cross-linking agent is chosen from a range of agents that are capable of forming inter molecular bonds with the reactive groups of the ligno-cellulosic material, possibly in the presence of a further cross-linking agent participating in the reaction. A preferable cross-linking reaction is the formation of ester bonds between carboxylic acids, the hydroxyl groups of the ligno-cellulosic structure, and polyols. Such a combination of cross-linking acid and polyol provide for improved dimensional stability of the pre-preg ligno-cellulosic mat, and the high degree of crosslinking obtainable between both the cellulosic matrix and the cross-linking agents provide for stable inclusion of other functional agents. Upon forming and curing of the pre-preg mat material, any functional additives present therein are at least partially fixated within the cross-linked structure of the material.

By naturally derived is herein meant any material or chemical agent that is obtainable from a natural source. The term also includes synthetically produced equivalents to such compounds, as well as mixes consisting essentially of such compounds. Preferably said at least one naturally derived cross-linking agent is a carboxylic acid having at least two carboxyl groups, even more preferably at least three carboxyl groups in combination with a polyol, preferably a polyol having at least six hydroxyl groups.

When even further increased durability is required for the end product, alternative cross linkers may be used. In one such embodiment, said at least one cross-linking agent is dimethyloldihydroxyethylene urea (DMDHEU), which is approved in the textile industry and is a commercially available cross-linker commonly used for cross-linking of cotton.

The use of naturally derived functional agents provides for good recyclability properties. The material is also well suited for combination with other type of materials, such as through laminating processes. Such a surface material or coating may be of different characteristics, which prior to recycling or during the recycling process may be removed. This embodiment is especially preferred in, for example, the construction or transport industry, thus providing similar moisture resistance and stability properties as conventionally used materials, still enabling recycling of the core material after removal of any protective layer potentially recycled in a different process.

Depending on the end application of the pre-preg ligno-cellulosic mat, as well as the product produced therefrom, it may be beneficial to add at least one further functionalisation agent. Such agents may be agents increasing the moisture resistance of the material, decreasing bio-activity, or fire retardants, as non-limiting examples. When the functional pre-preg mat is used for the production of elements and products intended for use in the construction industry or in the transport industry, the inclusion of fire retardants and/or hydrophobation agents may be beneficial.

Due to the non-toxic and environmentally friendly properties, an especially preferred embodiment utilises carboxylic acids well known and approved in the food and pharmaceutical industries such as, but not limited to, 1-hydroxypropane-1,2,3-tricarboxylic acid, propane-1,2,3-tricarboxylic acid, 2-hydroxynonadecane-1,2,3 tricarboxylic acid, 2-hydroxypropane-1,2,3-tricarboxylic acid, benzene-1,3,5-tricarboxylic acid and prop-1-ene-1,2,3-tricarboxylic acid. The polyol to be used in combination with the carboxylic acid is preferably selected from a range of polyols obtainable from natural sources, preferably widely used and approved in the food industry such as, but not limited to, xylitol, sorbitol and erythritol. These primary components are synthesised in a water based solvent or similar functional organic solvent in a variety of formulated ratios between 1:1 to 5:1 cross-linking acid to polyol, in one preferred embodiment the cross-linking acid to polyol ratio is 3:1. By water based solvent is herein meant any solvent that is based on water, including pure water.

The cross-linking formulation to be included in the functional solution is prepared under stirring in water or similar functionality organic solvent, such as alcohol, e.g. ethanol, at a temperature where the at least one cross-linking agents is dissolved but still mostly unreacted, meaning that essentially no unreversible conversion to the corresponding cross-linking product occurs, even though pre-linkage of the at least one cross-linking agent with possible further agents in the solution is allowed and even desired. The aim is to apply the cross-linking formulation to the ligno-cellulosic pulp matrix in a form where the cross-linking reaction is not yet initiated, thus enabling formation of cross-linking between the cross-linking agent and the reactive groups of the ligno-cellulosic pulp fibres. This results in reduced amount of available hydroxyl groups within the ligno-cellulosic structure of the pulp fibres and also provides for intra fiber cross-linking bonds.

The synthesising step of the cross-linking formulation is preferably performed at a temperature below 120° C., the optimal temperature being dependent on the characteristics of the cross-linking agent used. Preferably the temperature range is 10-119° C., even more preferably 60-119° C., and most preferably at 80-100° C. The duration of this preparation step is generally around 1 hour or more. Performing the step at an elevated temperature, still below the temperature of cross-link formation, such as an esterification reaction, has proven to increase the dimensional stability of the final product. This effect is obtained by preparing the cross-linking solution separately from the pulp mix, whereby a more even mixing result is achieved and the cross-linking agents may be pre-activated. The cross-linking formulation thus prepared is then added to the pulp fibres, forming a functional solution together with the water or alternative solvent of the pulp mass in the mixing unit. The functional solution is thereby to be interpreted as the liquid phase of the pulp mix including the cross-linking formulation and any optional further additives.

The total solid's ratio of the functional additives to the liquid phase of the treatment step, i.e., the functional solution, is preferably between 0.5 and 50% by weight depending on the cross-linking agent and optional additives used, as well as the intended end application and desired properties of stiffness, bending strength and moisture resistance. For a cross-linking formulation containing a combination of carboxylic acid and polyol, the functional solution, i.e., liquid phase, preferably has a solids content of 5-50% by weight after blending into the pulp mix. For DMDHEU, the solids content of DMDHEU is preferably 0.5-20% by weight in the liquid fraction of the treatment step, i.e., the functional solution.

The preparation of the cross-linking formulation can be carried out with a solids content close to the targeted solids content already in the synthesis stage, or alternatively it has been found that a very high solids content synthesis can be made which may be up to 90% solids to solvent ratio in the mixing and synthesis step, preferably from 70-80% solids to solvent (w/w). This very high solids solution can then be stored and dosed and mixed to the heated water in the mixing unit where the pulp is blended with the cross-linking formulation to achieve the targeted solids to solvent ratio and subsequent solids content in the functional pre-preg mat obtained from the drying step.

Any further functionalisation agent added in addition to the cross-linking agent may be chosen based on the intended end use of the product produced from the functional pre-preg ligno-cellulosic mat. The additional functionalisation agents are preferably added as solutions in water or similar functionality organic solvent, such as alcohol, e.g., ethanol. It might be beneficial to prepare such additional functional solutions separately from the cross-linking formulation to ensure that the pre-activation reaction of the cross-linking agents is not interfered with, thus reaching a high degree of cross-linking and hence stability in the cured product. This naturally depends on the properties of the functional additive, such as molecular size and reactive groups potentially interacting with the at least one cross-linking agent. A variety of solutions may be synthesised and applied either as combinations or separately. The preparation step of any such solution containing functional additives may be the same as described above.

To enhance the moisture resistance of the final product, it may be beneficial to add an agent increasing the hydrophobic and/or the anti-bacterial properties of the material. In a preferred embodiment, a hydrophobation emulsion comprising natural oils or waxes may be added to the pulp mix. Such a hydrophobation emulsion may be prepared from organic and commercially available substances with hydrophobic properties, i.e., hydrophobic agents, the primary constituents of which preferably include at least one substance selected fatty acid esters, fatty alcohols, other hydrophobic organic acids and hydrocarbons or additional or alternative functional substances selected from a range of pentacyclic triterpenoids such as, but not limited to oleanolic acid, betulin and betulinic acid. Such hydrophobic agents may be natural oils or waxes, or products derived from natural oils and waxes. In one preferred embodiment the hydrophobic agent is carnauba wax. Such naturally derived hydrophobic agents are also environmentally friendly and does not affect the recycling process in a negative way. Such non-toxic agents also enable use of the pre-preg mat material in food contact applications.

The synthesising of hydrophobation emulsion may be carried out in water or alcohol as base solvent, possibly in combination with a non-ionic surfactant commonly used in the art for oil in water emulsions. The hydrophobation emulsion usually requires a temperature where the hydrophobic agent is in liquid form, for most waxes the temperature should be above 60° C. Preferable temperatures for the preparation of the functional solution ranges from about 60° C. to 119° C., even more preferably from 80° C. to 100° C. The duration of this preparation step is often around 1 hour or more. The ratio of the solids content of the hydrophobic agents to the solids content of the at least one cross-linking agent is preferably from about 0.1% to 15% (w/w) in the functional solution, i.e., the liquid phase of the treatment step. Preferably, the surfactant ratio of the functional emulsion ranges between 0.1% and 50% by weight of the solids content of the hydrophobic agent. Solutions having different functionalities, and which are prepared separately, such as the cross-linking formulation and a hydrophobation emulsion as described above, are preferably mixed at an elevated temperature similar to the synthesising temperature, such as a temperature in the range of 60-119° C.

A further functional additive suitable for functionalisation of the ligno-cellulosic pre-preg mat is a solution containing lignin as additive which may be prepared from a variety of refined lignins, such as kraft lignin, acetylated lignin or commercially available modified lignin with a low molecular weight, such as less than 70 kDa, without being limited thereto. The lignin containing solution is prepared in a water based solvent or similar functionality solvent, such as alcohol, and preferably in the presence of a pH buffer, such as sodium hydroxide, sodium silicate, or sodium hypophosphate, or the likes, maintaining the pH of the solution above 6 before blending with the cross-linking formulation. The lignin may also be synthesised together with a further functional additive. Especially preferred is synthesising lignin together with a polyol, such as sorbitol, in a water based solvent or similar functionality solvent in connection with the preparation of the cross-linking formulation. Such a solution of lignin and polyol may form the basis for the cross-linking formulation, to which a cross-linking acid further is added.

The amount of lignin in the treatment solution may, for example, be in a range of 0.5-20%, depending on the molecular weight and grade of lignin. The functional solution containing lignin may be prepared at room temperature, or the lignin and the pH buffer may be added to an already synthesised cross-linking formulation, or as described above, into the synthetisation step. The pH buffer acts as a pH modifier preventing unwanted agglomeration of the lignin when becoming in contact with the cross-linking formulation of acidic nature. In a cross-linking formulation of tricarboxylic acid and polyol, the pH of the solution may be below 4, which without the pH modifier would cause the lignin to polymerise with itself. The lignin acts as a hydrophobation additive in the functional solution, providing increased moisture resistance and stability to the product. Due to the phenolic groups within lignin, a functional solution containing lignin may also provide antimicrobial properties to the material. The lignin may also provide natural binding functionality to the pre-preg mat obtained in the process.

In a further embodiment of the invention, a naturally derived or organic fire retardant, such as ammonium sulfate or phosphate, may be added to the functional solution, or the pulp mix, to improve the fire resistance properties of the final product. Such further functional agent may be added directly into any other functional formulation, as a separate solution prepared in water or alcohol, or directly into the mixing unit containing ligno-cellulosic pulp. The aim is to fixate the fire-retardant additive within the pre-preg mat upon curing of the cross-linking agents, preventing the fire retardant from leaching out of the material. The role of the fire retardant is primarily to slow down the rate of charring of the final product when exposed to fire conditions. The amount of fire-retardant additive can be in the range of 0.5-20% in the functional solution, i.e., the treatment solution.

The cross-linking formulation and any additional functional additive is added to the mixing unit containing ligno-cellulosic fibres, such as pulp fibres. The already synthesised cross-linking formulation may be combined with any additive prior to introduction into the mixing unit, or the cross-linking formulation and any optional additive may be added separately. The pulp fibres may be any kind of pulp fibres, for example, untreated kraft pulp, groundwood pulp, thermomechanical pulp, chemi-thermomechanical pulp (CTMP), bleached kraft pulp or never dried pulp directly from a pulp refiner. Previously dried pulp that is repulped and in wet state may also be used. Furthermore, recovered or recycled fibres from medium density fibreboard (MDF), fibre-based packaging etc., are also suitable as raw material for the disclosed process. The ligno-cellulosic pulp that is not yet treated, or is undergoing treatment with the cross-linking formulation and any additional functional solution, may optionally be blended with recycled material, preferably waste material from the shaping and forming process of the pre-preg mat or other ligno-cellulosic materials treated in a similar manner. By introducing any offcuts and trimming waste to the mixing unit, a recovery rate of more than 99% may be achieved within the process. Furthermore, it is possible to introduce end of life products prepared from similar material to the mixing unit. This especially applies for products that have not been fully cured, or even cured and finely chopped products in a limited amount, such as around 5-15% of the total content of pulp mass in the mix. The temperature in the mixing unit should remain below a temperature initiating cross-linking reactions, such as an esterification reaction between the hydroxyl groups of the ligno-cellulosic pulp material and a cross-linking acid and polyol. Preferably the temperature is below 120° C. Preferably the temperature in the mixing unit is a temperature above room temperature, such as from 25° C. or 40° C., more preferably from 60° C. to 119° C., and even more preferably from 80° C. to 100° C. Most preferred is a temperature from about 90° C. to 95° C. Any additional functional solution may be added at the same temperature ranges. The duration of the mixing step may be relatively short, such as 60-180 s.

In an especially preferred embodiment of the invention, recycled lignocellulosic fibres are introduced into the mixing unit. Especially preferable is the introduction of cut-off strands and chips of already treated pre-preg mat material or other ligno-cellulosic materials treated with similar cross-linking formulations as described herein, still being in an uncured state. The strands or chips of material are easily broken down in the presence of heated water and the chosen functional solution, and may be blended with virgin never dried pulp fibre.

Since the cross-linking formulation, or any other solution of functional additives, is prepared in water, or an alternative solvent with similar properties, such as alcohol, e.g., ethanol, which is fully mixable with the water base of the pulp, the ligno-cellulosic fibres of the pulp mass are quickly contacted with the cross-linking reagents and any additional functional agents. The mixing may thus be performed in a continuous process, where untreated pulp first is fed into a mixing unit, such as a batch pulper or other form of agitating mixer, and upon completing the repulping and mixing, the treated pulp fibres are transferred to a forming step. The ligno-cellulosic fibres are during the mixing step brought in contact with the at least one functional solution, including at least one cross-linking formulation and any further functionalisation agent optionally added, such as a hydrophobation emulsion or fire retardant. The treated fibrous solution may then be transferred to a head box or similar before being formed into a continuous mat in a wet laying process. The consistency of the fibrous solution is preferably 0.5-10%, even more preferably 1-3% pulp fibres to liquid.

The ligno-cellulosic fibres, such as pulp that has been treated with the at least one functional solution, i.e., the cross-linking formulation and possible additional functional solutions, is then discharged to dewatering process, preferably a physical or vacuum dewatering process, for the formation of a pulp mat. The dewatering process is most preferably performed using a twin wire press or a similar system. In a preferred embodiment, the residue solution removed in the dewatering process is recovered and circulated back to the mixing unit, where it is combined with the pulp and a solution of cross-linking formulation and possible additional functionalisation agent into a desired concentration. Preferably the residue solution is collected in an intermediary storage tank for re-dosing into the mixing unit. The intermediary storage tank also provides for easier pH control. Heated water may be added to the process to reach a desired solids content of functionalisation agents within the pre-preg ligno-cellulosic mat.

The pulp fibres that have been treated with the at least one functional solution in the mixing unit is formed into a continuous mat that preferably has a thickness of between 1.5 and 5 mm upon drying. This forming step may be performed simultaneously with the physical or vacuum dewatering process or in a further pressing step, any of which may be performed using techniques known in the art, such as using a mangle, belt press, vacuum or a double wire press.

The mat produced in the process is a web of pre-treated fibres, the predominant orientation of which may be in lengthwise direction of the mat due to the wet laying process. The mat is then transferred to a heat and drying zone for moisture removal via evaporation which may include vacuum. The drying should be performed in a temperature-controlled environment ensuring that the temperature of the ligno-cellulosic mat does not exceed a temperature of 120° C. During the drying step, the pre-preg ligno-cellulosic mat is preferably dried to a moisture content of about 20% or lower, more preferably about 15% or lower, or even more preferably about 10% or lower. Preferably the mat is dried to an equilibrium moisture content (EMC), which in a relative humidity (RH) of 55-60% is estimated to be 7-9%. Thus, the pre-preg mat may be dried to a moisture content of, for example, 8 or 6% or lower. This drying step may be performed using any technique known in the art intended for continuous drying, for example by use of a pre-heated oven, hot air circulation oven, microwave radiation, Infra-Red heating or hot surface contact heating, possibly in combination with specified vacuum to remove the excess moisture. Specific drying schedules can be used to speed up the water evaporation but leaving the solids in the pulp mat with the key objective of not rising the treated pulp mat to a temperature which would prematurely initiate a cross-linking reaction, the temperature of the mat thus preferably remaining below 120° C. The temperature of the surrounding may, however, be higher for a limited period of time, for example 180-200° C., as the temperature within the pre-preg ligno-cellulosic mat defines the initiation of a cross linking reaction. Since the thermal energy at this stage mainly is used to convert moisture into vapor, the temperature of the pre-preg ligno-cellulosic mat would still remain below the cross-linking temperature for a period of time that is dependent on the moisture content and the properties of the ligno-cellulosic mat, such as thickness, density and heat transfer properties. At longer drying times the temperature should be lower, such as temperatures below 120° C., for example within a range of 50-104° C. A temperature gradient may also be preferred, wherein moisture is first evaporated at higher temperatures and the mat is then transferred to a drying zone having a temperature below below 120° C. to ensure drying throughout the cross-section of the pre-preg ligno-cellulosic mat without initiating a cross-linking reaction.

After drying of the functional pre-preg mat of ligno-cellulosic material, the targeted grammage will be between 1500 and 5000 g/m². Such a high grammage pre-preg ligno-cellulosic mat may then be reeled into a roll or cut into sheets for easier handling.

The targeted dry solids content of the functional agents, including the cross-linking agent and any further functional agent remining in the mat after drying is determined based on the end application, preferably being at least 5 wt-% based on the total weight of the product. A total solids content of functional agents between 5 or 10 wt-% and 50 wt-% is most commonly targeted. More preferably the solids content is 10-30 wt-% and even more preferably 12-25 wt-%. In some embodiments, a solids content above 50 wt-% is preferred.

The pre-preg mat of ligno-cellulosic material obtained in the process of the invention may be stored and transported in the form of a roll or as individual sheets to a second manufacturing plant for formation of the end product or an intermediate product.

In one embodiment, the pre-preg mat of ligno-cellulosic material obtained in the process is subjected to a thermoforming step, either in a continuous process or separate product forming process. Before such a thermoforming step, it might be beneficial to further decrease the moisture content of the material and evacuate any absorbed humidity from the mid storage as well as to raise the temperature to a pre-reaction level ready for consolidation and forming of the final products. Such a pre-heating process may be applied to the pre-preg ligno-cellulosic mat by means of infra-red radiation, high-frequency, microwave or conventional hot air heating technologies. It may be carried out rapidly to a temperature of about 80 or 90 to 110° C. The pre-preg mat obtained in the process of the invention may also be further processed without additional drying steps, such that the moisture content during the forming step is below 10%. Preferably, the moisture content is lower during the forming step, such that it is below 8%, below 6% or ideally below 5% or 3%.

A preferable forming step for use in connection with the pre-preg ligno-cellulosic mat of the invention may simultaneously comprise heating and densification steps. The temperature in the forming step may be, for example, 100-170° C. or 120-140° C., thus initiating at least a partial cross-linking or activation of the material. Pressure is preferably applied to the pre-preg ligno-cellulosic mat under the forming step, as consolidation of the material has proven to reduce the moisture uptake and to increase the dimensional stability of the final product. The step of heating, forming and/or cutting of the final product may be carried out separately or simultaneously. Any thermoforming process known in the art may be used for the processing of the pre-preg ligno-cellulosic mat obtained in the process of the invention. One such preferable process is a continuous process described in the patent “Method for manufacturing products made from fibre material, and disposable products made by this method” with the application number PCT/FI2020/050511. A hydraulic press system may also be employed at the product forming step. Another preferred forming method is the use of a rotary roll press forming step. A further preferred forming method suitable for use with the pre-preg mat of the invention is an isostatic pressing system, such as the one described in the publication EP 2368700 B1, having the title “Production system comprising vibration means and pressurised gas supply for producing a composite component”.

The pressure used in a preferred forming step as described above may range from, for example, 300 kN to 3000 kN, as such a pressure treatment further enhances the strength and hydrophobicity properties of the end product. Preferably the pressure forming process is carried out at a temperature of 120° C. to 170° C., without being limited thereto. When the optional hydrophobation emulsion containing naturally derived hydrophobic agents is added, a pressing temperature below the melting temperature of the hydrophobic agent is preferred to avoid this to leach out of the material prior to curing. The duration of the pressure and heat treatment may be relatively short, especially for short life-span products, such as pressing times of for example up to 10 s, or 5-10 s, whereby only mild surface cross-linking is initiated and the pre-preg mat may still easily be cut and formed into desired shape. A short pressing time would enable easy repulping and recovery of the end product material as well. The potential is to utilise up to 99% of the fibres from the unreacted trimming waste. When producing long life-span high-durability products, the pressing time may be extended to minutes, such as 5-20 min, to simultaneously carry out the curing in the process. The pressing times disclosed herein are only examples of preferred process parameters suitable for processing of the pre-preg mat of the invention, and the duration of the forming step may vary depending on the intended use of the final product and the thickness of the material.

Any final product produced from the pre-preg ligno-cellulosic mat of the invention may thus be formed using any known technology suitable for the material, such as hydraulic mould press, roll forming, and cutting with such technologies as stamping, rotary embossing and cutting or laser cutting.

When the functional pre-preg mat of the invention is used as raw material in a cutting and forming process, the cutting step may be performed simultaneously or separately from the forming step. It has been found that for optimum cutting quality after the forming step the temperature of the formed mat is maintained at a temperature close to 100° C. or at least within a range between 80-120° C., which ensures a higher quality cut. This temperature range is also suitable for the above-mentioned forming steps. Likewise, the cutting may be performed under the above-mentioned forming conditions as well, such as at temperatures ranging up to 170° C. When the residence time of this thermoforming step is short enough to not initiate a final cross-linking reaction, the off-cut material can at this stage still be recycled and milled for re-use in the manufacturing of the pre-preg mat of ligno-cellulosic material.

To achieve maximum stability of a product produced from the pre-preg ligno-cellulsic mat of the invention, a final curing step is preferably carried out at temperatures ranging between 150° C. and 200° C., more preferably between 170° C. and 190° C., for a required time to complete the chemical cross-linking reaction and fixate any additional functional additives. For alternative cross-linking agents, such as DMDHEU, or when using a catalyst, the curing temperature might be lower, such as a temperature above 120° C. The duration depends on the size and thickness of the product and also the heating medium used. A variety of heating mediums known in the art, such as infrared radiation (IR), high frequency or heated fan ovens, may be used for the curing step. Commonly, a curing time of between 10 and 30 min is sufficient. In a preferred embodiment, a curing time of 15 minutes is applied at a temperature between 170° C. and 190° C. Any unreacted offcuts from the cutting process can be diverted before the final curing step and further processed and formed into alternative products and finally reacted under the same final curing step.

One example of a suitable catalyst is phosphoric acid. The catalyst may be used to initiate the formation of ester bonds at lower temperatures, thus contributing to energy savings upon formation of the final product. For a pre-preg material including tricarboxylic acid and polyol as cross-linking agents, FTIR analysis results indicated initiation of the esterification reaction at lower temperatures. In the presence of phosphoric acid as catalyst at a ratio of 1% by weight of catalyst compared to dry solids weight of the other acid and polyol, an esterification reaction was reached at temperatures in the range of 130° C., which was comparable to the results reached at 170° C. without a catalyst.

The pre-preg ligno-cellulsoic mat of the invention may be used as raw material in any of the above-mentioned thermoforming processes. Such processes may be used for the formation of both two- and three-dimensional products. Provided that the cross-linking agents and any further functionalisation agents are chosen from a range of non-toxic agents allowed in the food and pharmaceutical industry, the pre-preg ligno-cellulosic material is also suitable as raw material for the production of products intended for food contact applications, such single use cutlery and table ware as well as food packaging.

The pre-preg mat of ligno-cellulosic material is very versatile, and may likewise have applications in, for example, the construction or transport industry. In a further preferred embodiment, the pre-preg mat of ligno-cellulosic material may act as a core layer for products which may have a top and bottom film or layer applied through lamination during the forming stage. Such further processing of the material would provide a highly durable product for use in construction or the transport sector, for example as protective boards, elements providing improved stability, or in transport boxes. Since the core material is recyclable in a traditional cardboard recycling process, such films or coatings may be relatively easily removed prior to or during the process as the core is designed such that it will break down in a mechanical and water agitation process, or under hydrolytic conditions. The final product or the waste material may be shredded or chopped into smaller pieces, primary for ease of handling and speeding up of the delamination process. The unwanted, delaminated layers or fragments would preferably be separated in a mechanical process, for example a screening process, such that the ligno-cellulosic fibres may be recycled and reused, and the other materials may optionally be used for other applications.

The application of the cross-linking and optional hydrophobic agents in a water solution, or similar functionality solvent, at elevated temperature has been found beneficial with respect to the interaction between the ligno-cellulosic matrix and the cross-linking agent. The pre-preg mat of ligno-cellulosic material obtained shows upon curing a very good dimensional stability and reduced water uptake even at a relatively low solid content of the cross-linking agent and optional additional agents in the final product, such as around 20-30 wt-% and even lower.

The stabilisation of the ligno-cellulosic pulp material is in the present invention achieved by introducing a cross-linking formulation to a pulp mass, that thereafter is shaped into a mat and dried without carrying out a cross-linking reaction. The ligno-cellulosic mat thus obtained is suitable for final processing into end products either in a continuous process at the same manufacturing plant, or for transport and use at a different production site, where the cross-linking reaction is activated, thereby providing enhanced stability properties to the product.

The product produced of ligno-cellulosic pre-preg mat obtained in the process of the invention is recyclable in typical mechanical and water agitation process used for recycling of cardboard and paper to obtain individual cellulose fibres for new cardboard or paper products.

### Examples

The following tests were carried out to simulate the approach of industrially producing a thermo-formable pre-preg sheet material as described in the present disclosure. Two different raw materials were used in the experiment to demonstrate the potential of the technology to use virgin pulp material or a recycled post-consumer wood fibre material. In a test using virgin pulp material, the pre-preg sheet material was thermoformed and cured to evaluate the properties and strength of a product produced from such a pre-preg mat, without further processing steps or additives other than thermoforming and final curing by heat.

### Example 1: Softwood kraft pulp cellulose

Softwood kraft pulp cellulose was re-pulped in a lab scale pulper in a mix of water, citric acid and sorbitol with a ratio of 20% citric acid and sorbitol to 80% water. The solution was mixed in the pulp continuously for 1 minute before dewatering by hand using a wire mesh and rolling pin. The material was then dried in an oven at 100° C. until the remaining water had been evaporated. The pre-preg hand sheet was then thermoformed in a pre-heated hydraulic press for a period of 3 seconds and at 150° C. The formed sheet was then cut into strips for bending tests and these strips where then further exposed to a high temperature curing step at 175° C. for 15 minutes. The cured strips where then mechanically tested with a 3-point bending device to determine the kilogram (KG) of force applied to determine the strength to break point, as presented in Table 1 below.

TABLE 1
Strength test of uncured and cured
sample (virgin kraft softwood pulp)

| | Uncured | Cured |
|---|---|---|
| | Strength (KG) | Strength (KG) |
| Sample 1 | 1.05 | 2.44 |
| Sample 2 | 0.79 | 2.68 |
| Sample 3 | 0.88 | 2.23 |
| Average (sample 1-3) | 0.91 | 2.45 |

Further to the strength test, the material was also tested for moisture uptake by soaking the final thermoformed samples in room temperature water and weighed to determine the weight gain after 1 minute soaking as presented in the table below:

TABLE 2
Water soaking test of uncured and cured
sample (virgin kraft softwood pulp)

| | Uncured | | | Cured | | |
|---|---|---|---|---|---|---|
| | Dry (g) | 1 min (g)* | WPG % | Dry (g) | 1 min (g)* | WPG % |
| Sample 1 | 2.91 | 5.68 | 95 | 3.99 | 4.59 | 15 |
| Sample 2 | 3.48 | 6.04 | 74 | 4.14 | 4.66 | 13 |
| Sample 3 | 3.12 | 5.98 | 92 | 4.37 | 5.22 | 19 |
| Average | | | 86.8 | | | 15.7 |

*Weight after water soaking for one minute.
Average weight percent gain (WPG %) is calculated for samples 1-3.

From the results of the strength tests, it can be seen that the cured product on average shows strength properties that are around 2.5-fold the strength of the uncured material confirming a chemical cross linking reaction as a result of the introduction of the chemical formula in combination with the method described in the current disclosure to produce a pre-preg sheet material from ligno-cellulosic fibres. The water uptake weight gain after 1 min of soaking was reduced significantly after curing, having an average WPG % of 15.7% after curing compared to 86.8% for the uncured material also confirming chemical cross linking.

These tests thus shows that the pre-preg mat of the present disclosure thus is well suited for the formation of final products with improved moisture resistance and strength properties.

### Example 2: Fibres of recycled medium density fibreboard

Recycled medium density fibreboard wood fibres derived from softwood were mixed in a lab scale pulper in the recovered solution from the test in Example 1 based on the same ratio, being a mix of water, citric acid and sorbitol with a ratio of 20% citric acid and sorbitol to 80% water. The solution was mixed in the pulp continuously for 1 minute before dewatering by hand using a wire mesh and rolling pin. The material was then dried in an oven at 100° C. until the remaining water had been evaporated.

In the test it was found that the formation of the pre-preg mat of recycled medium density fibreboard was similar to that of Example 1 and that the pre-processing and mat formation could be carried out using similar methods regardless of the raw material used in these two tests.

### Example 3: Curing properties of pre-preg mat with and without inclusion of catalyst

An experiment was carried out to determine if the use of phosphoric acid in combination with a tricarboxylic acid and a polyol would act as a catalyst to initiate the ester bonds (esterification) at lower temperatures than in the absence of a catalyst.

The pulp was blended in an aqueous base containing the pre synthesised tricarboxylic acid, polyol and the catalyst in a ratio of 1% by weight of catalyst (phosphoric acid) compared to dry solids weight of the other acid and polyol. After blending the pulp was dried in an oven until bone dry. After drying the pulp samples were cured at a variety of temperatures ranging from 120° C. to 180° C.

After curing the treated pulp samples were chemically analysed using FTIR to determine the extent of esterification reaction occurring based on the peak intensity typically seen at around 1730. The experiment found that that a strong esterification peak could be achieved with a curing temperature of 130° C., achieving a comparable intensity to the level achieved without the inclusion of a catalyst at a temperature of between 170-180° C.

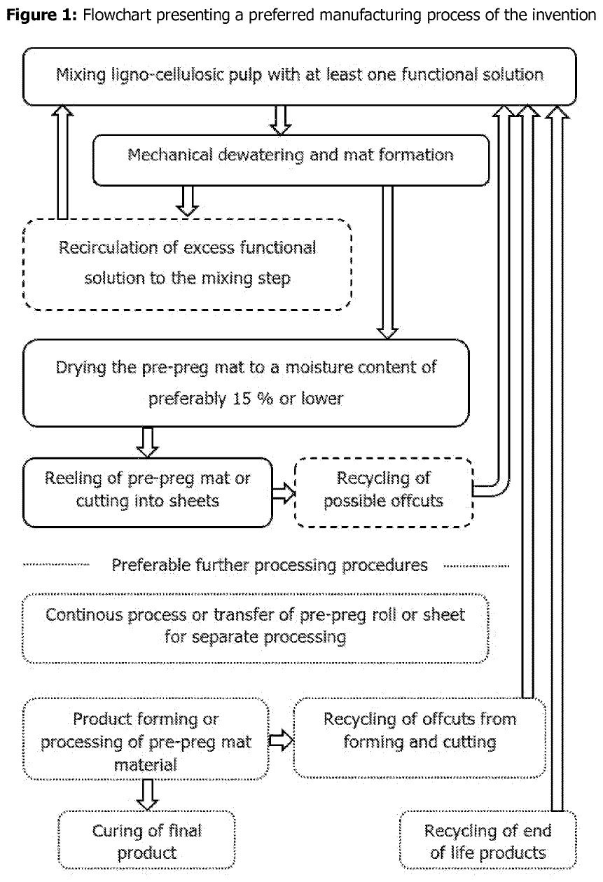

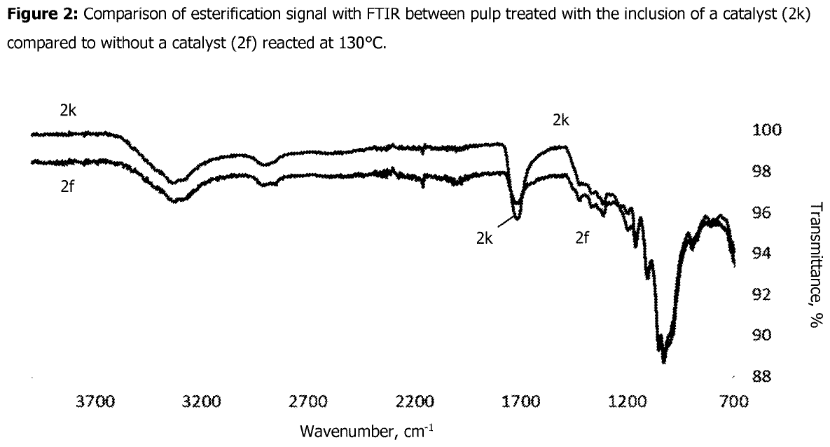

FIG. 2 presents a comparison of esterification signal with FTIR between pulp treated with the inclusion of a catalyst (2k) compared to without a catalyst (2f) reacted at 130° C.

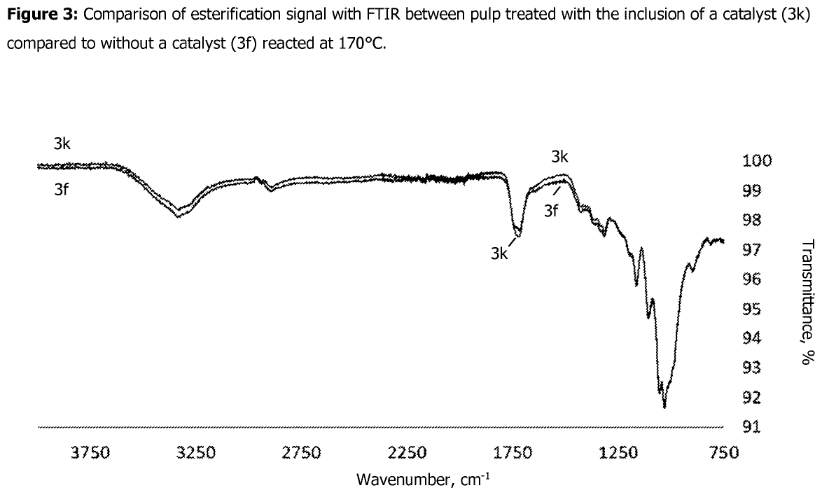

FIG. 3 presents a comparison of esterification signal with FTIR between pulp treated with the inclusion of a catalyst (3k) compared to without a catalyst (3f) reacted at 170° C.

1. A process for a manufacture of a functional pre-preg mat of ligno-cellulosic material, wherein:
ligno-cellulosic fibres are mixed with at least one functional solution including a cross-linking formulation containing at least one cross-linking agent, the at least one cross-linking agent is a carboxylic acid having at least two carboxyl groups in combination with a polyol, wherein the cross-linking formulation has been prepared by dissolving the at least one cross-linking agent in a water based solvent or alcohol based solvent at a temperature below 120° C.,
ligno-cellulosic fibres treated with the at least one functional solution are discharged to a dewatering process where excess solution is removed and the treated ligno-cellulosic fibres are formed into a continuous mat,
the mat of pre-preg ligno-cellulosic fibres formed in the previous step is transferred to a drying step during which a temperature within the ligno-cellulosic mat is kept below 120° C., the drying preferably being performed until a moisture content of the mat is 20% or less.

2. The process according to claim 1, wherein the ligno-cellulosic fibres are pulp fibres.

3. The process according to claim 1, wherein the at least one functional solution includes a hydrophobation emulsion.

4. The process according to claim 3, wherein said hydrophobation emulsion comprises at least one hydrophobic agent including at least one substance selected from fatty acid esters, fatty alcohols and pentacyclic triterpenoids.

5. The process according to claim 3, wherein said hydrophobation emulsion comprises at least one hydrophobic agent selected from a range of natural oils and waxes.

6. The process according to claim 1, wherein the at least one functional solution includes lignin as additive and a pH buffer.

7. The process according to claim 1, wherein the at least one functional solution includes a fire retardant additive.

8. The process according to claim 1, wherein the mixing of the ligno-cellulosic fibres and the at least one functional solution is performed at a temperature of 25-95° C.

9. The process according to claim 1, wherein the residue solution removed in the dewatering process is recirculated to the step of mixing ligno-cellulosic fibres with the at least one functional solution.

10. The process according to claim 1, wherein a thickness of the functional pre-preg mat of ligno-cellulosic material obtained from the drying step is 1.5-5 mm.

11. The process according to claim 1, wherein a grammage of the functional pre-preg mat of ligno-cellulosic material obtained from the drying step is 1500-5000 g/m².

12. The process according to claim 1, wherein uncured waste material of ligno-cellulosic fibres treated with at least one cross-linking formulation is recycled into the step of mixing ligno-cellulosic fibres with the at least one functional solution.

13. A functional pre-preg mat of ligno-cellulosic material suitable for use as raw material in a thermoforming process, wherein the pre-preg mat of ligno-cellulosic material is obtained by the process of claim 1.

14. A method of using a functional pre-preg mat of ligno-cellulosic material obtained in the process of claim 1 in a thermoforming process, wherein the pre-preg mat of ligno-cellulosic material is formed into a product and the shaped product is cured.

15.-16. (canceled)

17. The process according to claim 4, wherein said at least one substance is selected from oleanolic acid, betulin and betulinic acid.

18. The process according to claim 5, wherein the hydrophobic agent is carnauba wax.

19. The process according to claim 1, wherein the residue solution removed in the dewatering process is recirculated to the step of mixing ligno-cellulosic fibres with the at least one functional solution through an intermediate tank from which the recirculated functional solution is configured to be re-dosed into the process.
